(19) United States
(12) Patent Application Publication
(10) Pub. No.: US 2002/0181192 A1
(43) Pub. Date: Dec. 5, 2002

(54) Notebook computer with multi-purpose hot keys

(76) Inventors: Yu-Fu Huang, Gueishan Shiang (TW); Tsung-Yi Chen, Banchiau City (TW)

Correspondence Address: RABIN & BERDO, P.C., Suite 500, 1101 14th Street, N.W., Washington, DC, 20005, US

(21) Appl. No.: 10/108,861

(22) Filed: Mar. 29, 2002

(30) Foreign Application Priority Data
Jun. 4, 2001 (TW) 90209208

(51) Int. Cl. G06F 1/16; B41J 3/54

(52) U.S. Cl. 361/683; 361/680; 400/82

(57) ABSTRACT

A notebook computer with multi-purpose hot keys comprising a platform inside which a motherboard is situated and a covering board on which a screen is situated is provided. A fast select program is stored in the motherboard. A set of multi-purpose hot keys including a number of select keys and an Enter key is situated on the platform besides an ordinary input keyboard. The hot keys can open a fast select application program and have a fast select menu displayed on the screen, wherein the select key selects and the Enter key executes the selected item. The hot keys can further cooperate with the screen brightness adjustment program, volume adjustment program, color contrast adjustment program and the suspend function so as to adjust the intensity of screen brightness, loudness of volume, ratio of color contrast and bring the computer systems into suspend status respectively. The multi-purpose hot keys for a notebook computer replace conventional built-in hot keys on a keyboard, allowing the users to select commonly used programs in a systematic way, facilitating a convenient way of operation.

This application incorporates by reference Taiwanese application Serial No. 90209208, Filed Jun. 4, 2001.

### BACKGROUND OF THE INVENTION

1. Field of the Invention

The invention relates in general to a notebook computer, and more particularly to a notebook computer with multi-purpose hot keys.

2. Description of the Related Art

In the age of technology, computer has become an indispensable appliance for modem people in their work and entertainment as well. Compared to a desktop computer, a notebook computer is lighter in weight and smaller in size. Since the notebook computer is so compact and portable, it has won great popularity with the users. Apart from an input keyboard, the platform of notebook computer has been equipped with hot keys in recent years. Along with the increase in peripheral equipment and the advance in the Internet, more and more hot keys with functions such as Internet and e-mailing are needed. The users can also assign the keys of the keyboard as hot keys to open their commonly used application programs promptly.

Please refer to FIG. 1, a schematic diagram of a conventional notebook computer is illustrated. The notebook computer includes two parts which are jointed together via a pivot joint: a covering board 110 on which a screen 112 is situated and a platform 120 inside which a motherboard (not shown here) is situated. A keyboard 122 to which the motherboard is coupled is situated on the platform 120. In order to incorporate hot key software, the users can either have hot keys 124 installed on the platform or set any key in the keyboard 122 as a hot key to meet their needs. The main drawback of this well-known technology is that the number of the hot keys 124 installed or set is restricted due to limited space of the platform and limited keys the keyboard 122 has. Besides, too many hot keys 124 not only make the platform 120 of notebook computer look messy, but also prevent the keys in the keyboard 122 from integrating the intended fast select items in a systematical way. Apart from that, when more and more hot keys are set in the keyboard 122, the more likely the users would forget about or be confused with which fast select function a key represents. It is very likely that the desired select function can hardly be located without several trials and errors, which reduces the desired effect of being fast.

### SUMMARY OF THE INVENTION

It is therefore an object of the invention to provide a notebook computer with multi-purpose hot keys. The hot keys installed on the platform of a notebook computer allow the users to execute select functions in a systematical way, while the fast select menu incorporating several commonly used items displayed on the screen not only facilitates operating convenience, but also achieves the integration of a fast select system.

According to the object of the invention, a notebook computer with multi-purpose hot keys comprising two parts which are jointed together via a pivot joint: a covering board on which a screen is situated and a platform inside which a motherboard is situated. A keyboard is situated on the platform. The motherboard to which the keyboard is coupled has a fast select function. A set of multi-purpose hot keys including a number of select keys and an Enter key is situated on the platform. The hot keys open the fast select application program and display a fast select menu on the screen; the items on the select menu can be selected using a number of select keys and executed using an Enter key. A number of Lighting Emitting Diode (LED) can be installed below the hot keys indicating their operation status. The hot keys can further cooperate with the screen brightness adjustment program, volume adjustment program, color contrast adjustment program and the suspend function so as to adjust the intensity of screen brightness, loudness of volume, ratio of color contrast and bring the computer systems into suspend status respectively.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 shows a schematic diagram of a conventional notebook computer;

FIG. 2 shows a schematic diagram of a notebook computer with multi-purpose hot keys according to a preferred embodiment of the invention; and

FIG. 3 shows a schematic diagram of the hot keys in FIG. 2.

### DESCRIPTION OF THE PREFERRED EMBODIMENT

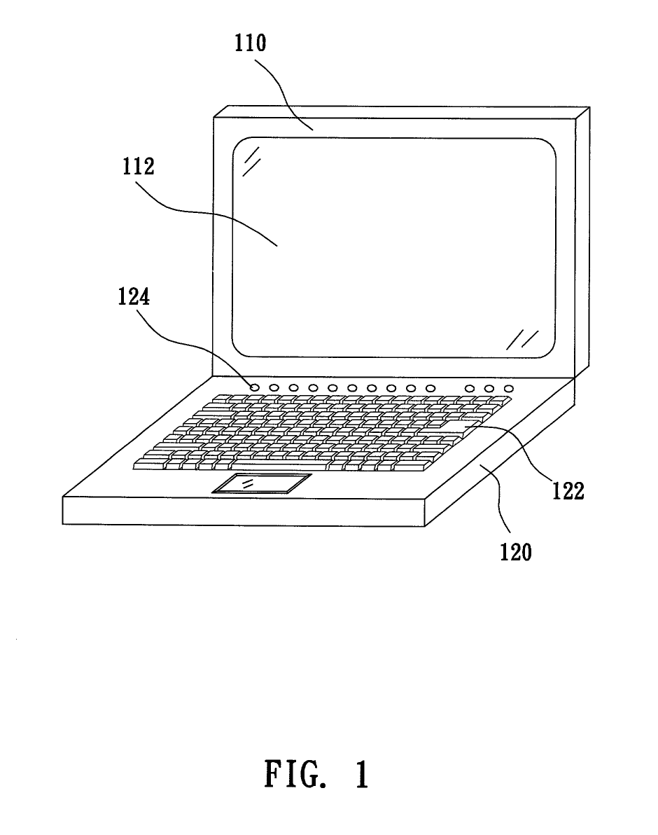

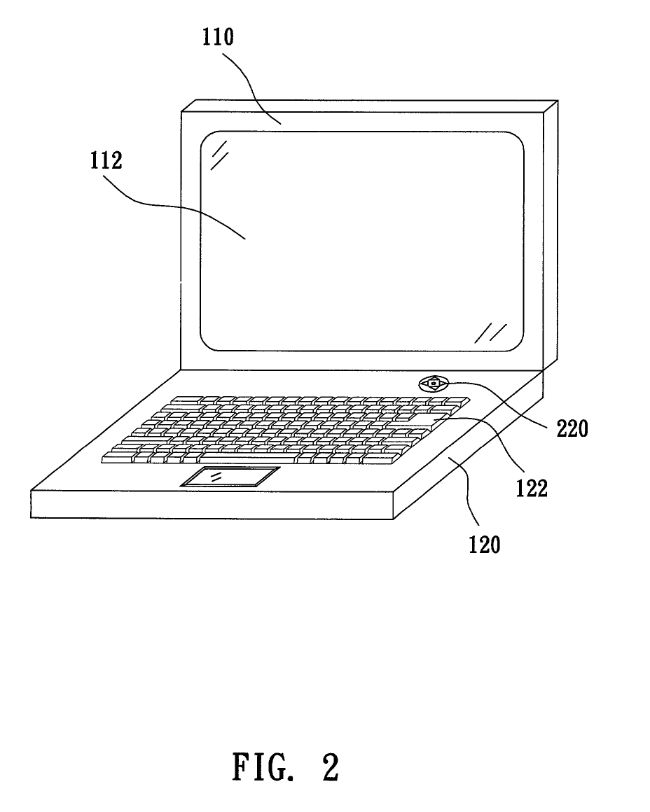

Referring to FIG. 2, a schematic diagram of a notebook computer with multi-purpose hot keys according to a preferred embodiment of the invention is illustrated. In terms of outward appearance, FIG. 2 differs from FIG. 1 in the platform 120. In addition to an input keyboard 122, which is situated on top of the platform 120 and is coupled to the motherboard inside the platform (not shown in FIG. 2), the platform in FIG. 2 has multi-purpose hot keys 220 and a number of indicating lights (not shown in FIG. 2). The motherboard has a fast select program stored inside it, which can be opened using multi-purpose hot keys 220. A select menu, which includes some commonly used select items, will be displayed on a screen 112 when the fast select program is opened. However, the users can change items to be included on the select menu to meet their needs. They can use hot keys 220 to select items on the select menu and have them executed. A number of indicating lights, Lighting Emitting Diode (LED) for instance, are situated below the multi-purpose hot keys 220 indicating whether the multi-purpose hot keys 220 have been clicked on and also whether the execution instructions have been received by the computer system or not. When the indicating lights are on or flashing, it signifies that the computer system is executing instructions making the operation status of hot keys 220 clearer to the user.

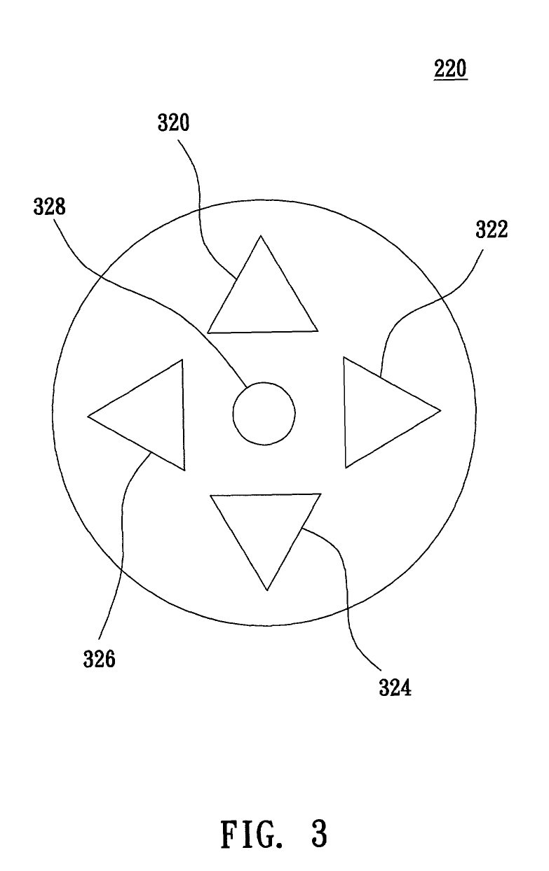

Referring to FIG. 3 a schematic diagram of the hot keys in FIG. 2 is illustrated. Hot keys 220 include a number of select keys and an Enter key. Four select keys are used as an example in this preferred embodiment of the invention. The select keys include: a first select key 320 used to trigger off an upward signal; a second select key 322 used to trigger a rightward signal; a third select key 324 used to trigger a downward signal; and a fourth select key 326 used to trigger a leftward signal. An Enter key 328 triggering an execution signal is situated at the center of the select keys. However, the invention is not limited to the number of hot keys, ways of arrangement and shifting of signals as disclosed in the embodiment. The scope of the invention encompasses any use of multi-purpose hot keys to achieve any select and execution functions.

The hot keys 220 can further cooperate with the suspend function and adjustment programs (screen brightness, volume and color contrast adjustment programs for instance) to adjust the intensity of screen brightness, loudness of volume, ratio of color contrast and bring the computer system into suspend status. By means of specific settings, the computer system knows which program to open, a fast select program or an adjustment program? For instance, double click the Enter key quickly to start the fast select program. When the fast select program has been opened, all the keys in the multi-purpose hot keys 220 can be used to select and execute items on the fast menu.

If the fast select program is not opened, which means the Enter key 328 had not been double clicked (for instance, only single click was performed), all the keys in the multi-purpose hot keys 220 will be used to trigger off the adjustment programs and suspend function. For example, if the user single clicks the Enter key 328, the suspend function will be triggered off with the suspend status indicating light being on, and the computer system will be in a suspend status to save power consumption. If the user single clicks the first select key 320, the screen brightness adjustment program will be triggered off with a screen brightness adjustment icon being displayed on the screen. By means of the second select key 322 and the fourth select key 326, the cursor in the adjustment icon can be shifted. After the desired adjustment has been achieved, the user can click the first select key 320 to finish the adjustment of screen brightness. Similarly, the second select key 324 can be used to open a volume adjustment program, and the third select key 324 a color contrast program. However, the cooperation between the multi-purpose hot keys 220 and the fast menu, the adjustment programs and the suspend function is not limited to the forms of opening or ways of operation disclosed in the embodiment of the invention. The scope of protection of the invention encompasses any use of multi-purpose hot keys to open, control and execute the adjustment programs and suspend function.

The notebook computer with multi-purpose hot keys disclosed in the foregoing preferred embodiment of the invention has the following advantages:

1. By means of the cooperation between the multi-purpose hot keys and software like fast select programs, a large number of select items can be integrated in a systematical way to solve the problem of limited space and keys in the input keyboard.

2. The fast menu displayed on the screen, being clear at a glance, helps the users to locate their desired select items in a systematical way. Besides, the upward, downward, leftward and rightward shifting method of the multi-purpose hot keys make it easy and convenient in the selection and execution of the select items.

3. The multi-purpose hot keys having been combined with the suspend function as well as the screen brightness adjustment program, volume adjustment program and color contrast adjustment program reduce the number of input keys needed on the platform of a notebook computer. This simplified design of a notebook computer, whose outward appearance is beautiful and tasteful, allows the notebook computer to remain only necessary input keys on the platform.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A notebook computer with multi-purpose hot keys, comprising:
a covering board with a screen; and
a platform which is jointed together with the covering board via a pivot joint, comprising:
a motherboard, which comprises a fast select program;
an input keyboard being situated on the platform is coupled to the motherboard; and
a multi-purpose hot key, being situated on the platform and coupled to the motherboard, comprises a plurality of select keys and an Enter key.

2. A notebook computer with multi-purpose hot keys according to claim 1, wherein the multi-purpose hot keys further comprise a plurality of indicating lights used to show the operation status of the hot keys.

3. A notebook computer with multi-purpose hot keys according to claim 2, wherein the indicating light is a Light Emitting Diode (LED).

4. A notebook computer with multi-purpose hot keys according to claim 1, wherein the multi-purpose hot key can start a fast select program and have a fast menu displayed on the screen.

5. A notebook computer with multi-purpose hot keys according to claim 4, wherein the select key can select an item on the fast menu.

6. A notebook computer with multi-purpose hot keys according to claim 4, wherein the Enter key can execute an item on the fast menu.

7. A notebook computer with multi-purpose hot keys according to claim 1, wherein the multi-purpose hot key can start a screen brightness adjustment program and have a screen brightness adjustment icon displayed on the screen.

8. A notebook computer with multi-purpose hot keys according to claim 7, wherein the select keys can control the screen brightness adjustment icon and adjust the intensity of screen brightness.

9. A notebook computer with multi-purpose hot keys according to claim 1, wherein the multi-purpose hot key can start a volume adjustment program and have a volume adjustment icon displayed on the screen.

10. A notebook computer with multi-purpose hot keys according to claim 9, wherein the select keys can control the volume adjustment icon and adjust the loudness of volume.

11. A notebook computer with multi-purpose hot keys according to claim 1, wherein the select keys can control a color contrast adjustment icon and adjust the ratio of color contrast.

12. A notebook computer with multi-purpose hot keys according to claim 11, wherein the select keys can control the color contrast adjustment icon and adjust the ratio of color contrast.

13. A notebook computer with multi-purpose hot keys according to claim 1, wherein the Enter key can further start a suspend function.

14. A multi-purpose hot key, which is installed at a notebook computer wherein the notebook computer has a screen, comprising:
a plurality of select keys; and
an Enter key.

15. A multi-purpose hot key according to claim 14, further comprising a plurality of indicating lights to indicate the operating status of multi-purpose hot keys.

16. A multi-purpose hot key according to claim 15, wherein the indicating light is a Light Emitting Diode (LED).

17. A multi-purpose hot key according to claim 14, wherein the select keys can start a fast select program and have a fast menu displayed on the screen.

18. A multi-purpose hot key according to claim 17, wherein the select keys can select an item on the fast menu.

19. A multi-purpose hot key according to claim 17, wherein the Enter key can execute an item on the fast menu.

20. A multi-purpose hot key according to claim 14, wherein the multi-purpose hot key can start a screen brightness adjustment program and have a screen brightness adjustment icon displayed on the screen.

21. A multi-purpose hot key according to claim 20, wherein the select keys can control the screen brightness adjustment icon and adjust the intensity of screen brightness.

22. A multi-purpose hot key according to claim 14, wherein the multi-purpose hot key can start a volume adjustment program and have a volume adjustment icon displayed on the screen

23. A multi-purpose hot key according to claim 22, wherein the select keys can control the volume adjustment icon and adjust the loudness of volume.

24. A multi-purpose hot key according to claim 14, wherein the select keys can start a color contrast adjustment program and have a color contrast adjustment icon displayed on the screen

25. A multi-purpose hot key according to claim 24, wherein the select keys can control the color contrast adjustment icon and adjust the ratio of color contrast.

26. A multi-purpose hot key according to claim 14, wherein the Enter key can further start a suspend function.

27. A multi-purpose hot key according to claim 17, wherein the select keys further comprises: a first select key, a second select key, a third select key and a fourth select key.

28. A multi-purpose hot key according to claim 27, wherein the first select key can trigger off an upward signal.

29. A multi-purpose hot key according to claim 27, wherein the second select key can trigger off a rightward signal.

30. A multi-purpose hot key according to claim 27, wherein the third select key can trigger off a downward signal.

31. A multi-purpose hot key according to claim 27, wherein the fourth select key can trigger off a leftward signal.

32. A multi-purpose hot key according to claim 26, wherein the Enter key is situated at the center of the select keys.

33. A multi-purpose hot key according to claim 26, wherein the Enter key can trigger off an execution signal.
